(19) United States
(12) Patent Application Publication
(10) Pub. No.: US 2012/0267948 A1
(43) Pub. Date: Oct. 25, 2012

(54) WIRELESS NETWORK-COMPATIBLE MICROWAVE OVEN FOR AIRCRAFT AND OTHER PASSENGER TRANSPORT VEHICLES

(75) Inventors: SCOTT RICHARDS, South Riding, VA (US); Paul Robinson, Front Royal, VA (US)

(73) Assignee: MAG AEROSPACE INDUSTRIES, INC., Carson, CA (US)

(21) Appl. No.: 13/453,021

(22) Filed: Apr. 23, 2012

Related U.S. Application Data
(60) Provisional application No. 61/477,727, filed on Apr. 21, 2011.

(51) Int. Cl. H02G 3/02

(52) U.S. Cl. 307/9.1

(57) ABSTRACT

Embodiments of the present invention provide a power supply for a microwave oven designed for use on-board an aircraft and that is configured to deliver power to the microwave magnetron in such a way as to avoid interference with Wi-Fi networks. Output from the power supply to the microwave oven is modulated and optimized by lowering the time period that the power is delivered (e.g., into short bursts), but increasing the actual current that is delivered.

### CROSS REFERENCE TO RELATED APPLICATIONS

This application claims the benefit of U.S. Provisional Application Ser. No. 61/477,727, filed Apr. 21, 2011, titled “Microwave Oven Wireless Network Compatiblity via Modulated Output,” the entire contents of which are hereby incorporated by reference.

### FIELD OF THE INVENTION

Embodiments of the present invention relate generally to microwave ovens compatible with wireless networks and designed for use on aircraft and other passenger transport vehicles. Power received by the microwave oven is modulated and optimized by lowering the time period that the power is delivered (e.g., into short bursts), but increasing the actual current that is delivered.

### BACKGROUND

It has become more and more common for airlines to offer wireless internet access to passengers during flights. This is a beneficial service that many passengers have begun to enjoy—and often expect. Wi-Fi access allows an electronic device to exchange data wirelessly (using radio waves) over a computer network, including high-speed Internet connections, and includes any “wireless local area network” (WLAN). However, one challenge with offering Wi-Fi access on-board an aircraft is that some of the on-board appliances may interfere with the signals. As a particular example, Wi-Fi and microwave ovens often operate in the same frequency bands, which can cause interference and lower efficiencies.

Wi-Fi and microwave oven manufacturers are required by the FCC to operate within any of a finite number of allocated frequency bands (ISM bands). Based on a variety of factors, the band that is chosen by both manufacturers is the 2.4-2.5 GHz band. Operation on the same band causes a potential for microwave ovens to interfere with Wi-Fi equipment when both are in use. Wi-Fi manufacturers, however, have employed a variety of clever methods to operate effectively in the presence of domestic and commercial (on-land) microwave ovens. One of those methods is to take advantage of the fact that domestic microwave ovens are actually “off” for half of every power line cycle which, in the United States, works out to be about 8 milliseconds for every 16 milliseconds.

However, domestic and commercial microwave ovens work differently from microwave ovens that are designed for use on-board aircraft. Specifically, most aircraft microwave ovens are designed to operate directly from aircraft power (generally 28VDC or 115VAC, 400 Hz, 3 phase) and are forced to use a different type of power supply which keeps the magnetron on 100% of the time. This is in contrast to domestic and commercial microwave ovens that generally use 115V, 60 Hz. Accordingly, the Wi-Fi systems on-board aircraft do not have moments of “quiet” in which they can send information packets. Additionally, Wi-Fi/microwave oven interference is a more difficult challenge to address on an aircraft, which is essentially a confined metal tube with a number of reflective surfaces that can cause interference. The fuselage of the aircraft tends to confine microwave oven emissions, which can then interfere with Wi-Fi channels. (This is, for example, in contrast to microwave oven/Wi-Fi usage in homes and businesses, where there are not steel walls that reflect energy back into the building.) Until recently, Wi-Fi systems on aircraft were very rare, but that is changing rapidly, and there is thus a need for aircraft microwave ovens that are “Wi-Fi compatible.”

The only way that a traditional (domestic or commercial) microwave oven can be used on-board an aircraft is by using an inverter on the aircraft in order to convert the incoming aircraft power to a useable power supply. However, inverters are large, heavy, and expensive and are thus not practicable for use on aircraft, where weight and space limitations are of primary concern. Additionally, there are many design considerations that are included on aircraft microwave ovens that are not provided on traditional microwave ovens because the intended uses are different. It is thus desirable for aircraft component manufacturers to be able to incorporate certain requested design features into their microwave ovens, without being limited to off-the-shelf, traditional microwave oven designs, but to also provide aircraft microwave ovens that are Wi-Fi compatible without an inverter.

### BRIEF SUMMARY

Embodiments of the invention described herein thus provide a power supply for a microwave oven designed for use on-board an aircraft and that is configured to deliver power to the microwave magnetron in such a way as to avoid interference with Wi-Fi networks. Output from the power supply to the microwave oven is modulated and optimized by lowering the time period that the power is delivered (e.g., into short bursts), but increasing the actual current that is delivered to maintain the original cooking power.

Certain aspects relate to a power supply module for use with a microwave oven on-board an aircraft, comprising a power converter configured to accept incoming aircraft power and convert the incoming power to controllable high frequency power; a pulser configured to convert the high frequency power to a lower duty cycle; and a power amplifier to supply a greater than normal amount of non-continuous outgoing power over bursts of time. The power supply module is generally installed in a microwave that is designed for use on-board an aircraft. In a certain aspect, the lower duty cycle comprises about a 50% duty cycle, such that the power is on about 50% of the time and off about 50% of the time. The greater than normal amount of power supplied may be about twice the normal amount of power required by a microwave magnetron. In one example, the power delivered to the magnetron is at about 500 mA. The power supplied may employ 5-100 millisecond bursts over a 10-200 millisecond period. More specifically, the power may be supplied in 6-8 millisecond bursts over 16 millisecond cycles. The power supply module generally mimics the behavior of a power supply of a domestic microwave oven and supplies power to a magnetron of the microwave oven. In one aspect, the power supply module is positioned in direct communication with the microwave oven on-board an aircraft. A further aspect relates to an aircraft galley comprising a microwave oven using the above described power supply.

A further aspect relates to a method for delivering power to a microwave oven on-board an aircraft, comprising: converting the incoming aircraft power to a controllable high frequency power; pulsing the high frequency power at a lower duty cycle; and delivering a greater than normal amount of non-continuous, outgoing power over bursts of time.

### BRIEF DESCRIPTION OF THE DRAWINGS

FIG. 1 shows one embodiment of power flow from the aircraft power source to an on-board microwave oven.

FIG. 2 shows a schematic view of an aircraft with a microwave oven having a power supply module incorporated therein.

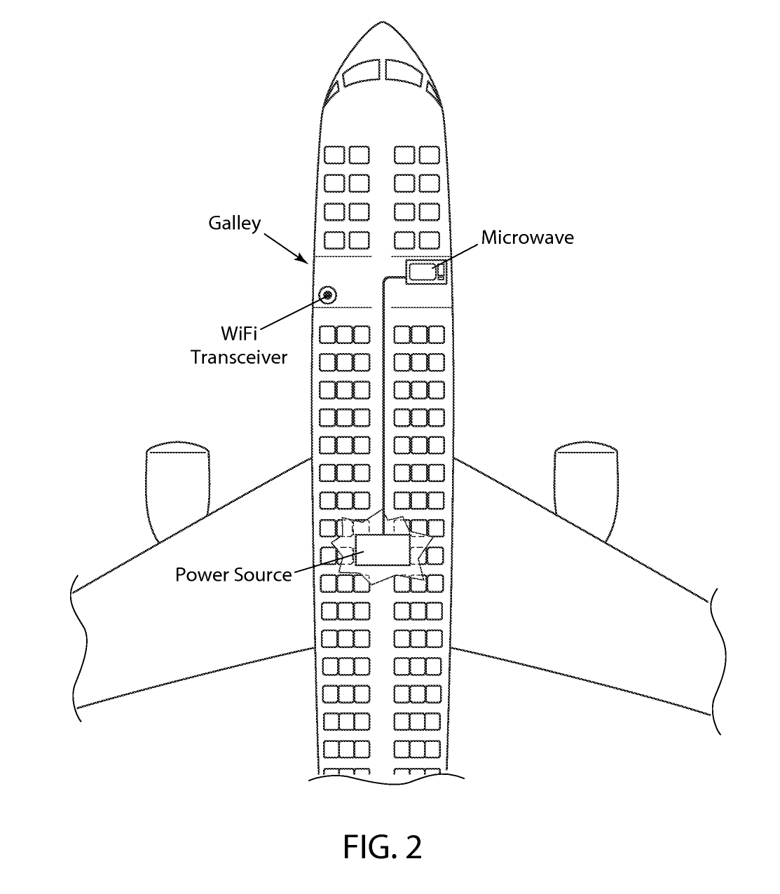

FIG. 3 is an alternate bock diagram showing flow of power from an aircraft power source to a magnetron.

### DETAILED DESCRIPTION

Embodiments of the present invention provide an improved microwave oven power supply for use with microwave ovens designed to be mounted on-board an aircraft or other passenger transport vehicle. The power supply is generally intended to be built into the microwave oven, but it is possible to provide the power supply as a stand-alone unit that can be used to retrofit existing microwave ovens. The power supply is designed to alter the power delivered to the on-board microwave oven so that it can accept and use aircraft power, but more closely mimics the behavior of a domestic microwave oven.

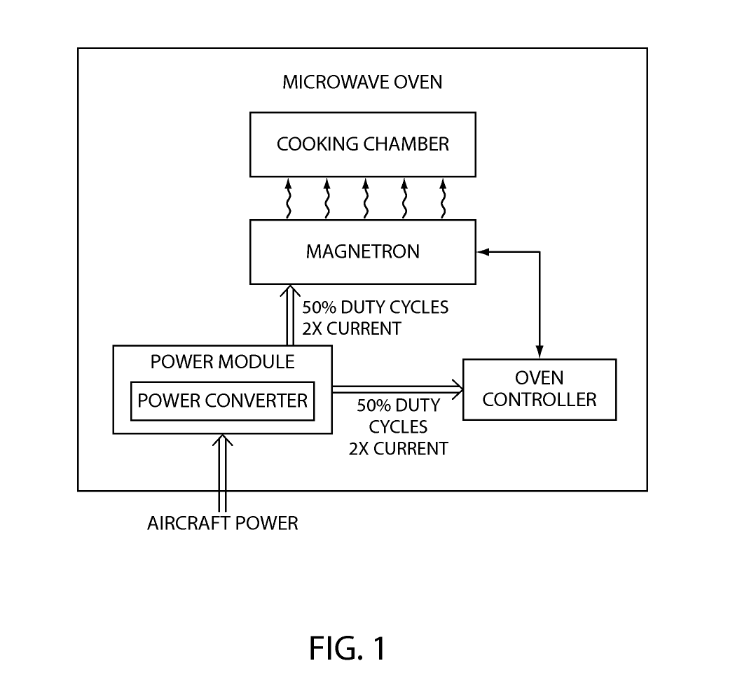

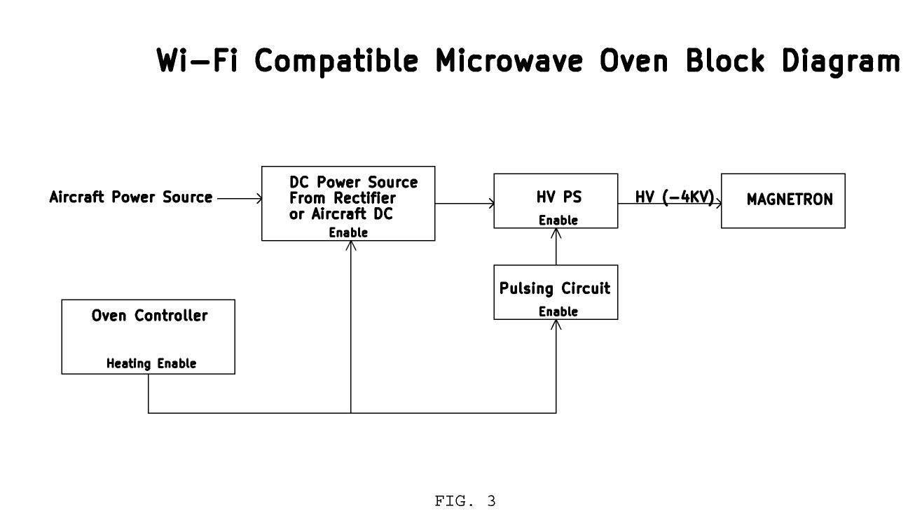

As shown in FIG. 1, the microwave oven can receive power directly from the aircraft, without the use of an inverter. The power is delivered to the power supply module, which includes a power converter. The power converter converts or rectifies the incoming AC power to DC power or directly uses DC power from the aircraft. The power supply module also has a power controller or a pulser or pulsing circuit as outlined in FIG. 3. The pulser is designed to effectively cause the power supply to switch or turn on and off at a very fast rate. The rate of switching is typically specified at the point of manufacture of the microwave oven, but it may be designed to be adjustable by the end user if desired. In one example, the aircraft microwave oven power supply provides a 50% duty cycle, supplying a greater than normal amount of power in short bursts over a longer period of time thereby preserving cooking power.

The desired results may be achieved by delivering about twice the normal amount of power (2×) in about half the amount of total time (50%), although other ranges are possible. For example, the power supply may alternatively provide a 30%, 40%, 60% or 70% duty cycle, supplying varying amounts of power over varying amounts of time. The amount of time over which the power is delivered is less than 100%, and generally less than 70%. In a specific embodiment, it is about 50%, meaning that power is only delivered to the microwave oven about half the time, generally in very small bursts. This allows the delivery of intermittent power to the magnetron of the microwave oven.

The oven controller can control operation of the microwave oven, such as cooking time, “on” and “off” modes, cooking power level, etc. In some embodiments, the oven controller is communicatively coupled to a user interface that can receive commands from a user and that can transport electronic representations of those commands to the oven controller. The oven controller can respond to the representations by controlling the magnetron in accordance with the commands.

In one example, the switching rate may supply power in 1-500 millisecond bursts over a 2-1000 millisecond period or duty cycle. In a more particular embodiment, the power may be supplied in 5-100 millisecond bursts over a 10-200 millisecond period. In an even more specific embodiment, the power may be supplied in 6-10 milliseconds over a 10-20 millisecond period. In a very particular embodiment, the power may be supplied in 6 or 8 milliseconds over a 16 millisecond period. It should be understood that the specifics of these power supply time ranges may be varied, while keeping the same general operating principle of supplying greater than normal amounts of power over smaller units of time.

The amount of power delivered in these units of time, however, is about twice the amount of power that is normally delivered to the microwave oven. In other words, a greater than normal amount of power is supplied, and in some instances, it is about twice the normal amount of power (2×), although other ranges are possible. For example, the current may be delivered at about 1.5×, 1.75×, 2×, or even at higher than 2×, such as 2.25×, 2.5×, 3× or even up to 5×. Because the amount of time over which the power is delivered is less than 100%, it is desirable that a greater amount of current be delivered during the “on” times to maximize the available “off” time for a given cooking power.

Specifically, once the power converter converts the aircraft AC power to DC power, the pulser causes pulsed (on/off) delivery of the power, and the amount of power delivered is increased—or amplified—during the “on” times. This may be accomplished via a power amplifier or any other appropriate power increasing device. One reason that the power is converted from AC to DC is so that the power can be converted to a stable voltage that can be transformed. (There is little control over the initial incoming frequency of the aircraft power.) It is desirable to then convert the DC to a controlled and relatively high DC voltage at the desired level. In order for this to happen, the DC power is converted back to AC power, but at a relatively high frequency (many kHz or even MHz). The use of a high frequency enables the major power components to be relatively small and light without consequent loss of effectiveness. The power has then to be transformed to a voltage that is high enough to operate the magnetron (the device that generates the microwaves for the microwave oven), which is typically about −4000 Volts. This may be done via combination between a power converter, a power transformer, and/or a power amplifier. The outgoing power is then used to gate the microwave oven magnetron on and off at the comparatively lower rate indicated above. Given that the aircraft Wi-Fi data rate at any moment in time is usually well below 100% of the available capacity (given the relatively slow Internet upload/download bit rates), the potential reduction in communication capacity due to interference 50% of the time may be tolerable or even unnoticed.

Further, the inventors have found that the frequency of the magnetron is, in general, more stable at higher current (greater than 450 mA) than at lower current (less than 450 mA). The stable magnetron frequency tends toward 2.47 GHz, which would interfere only with the higher channels (greater than channel 6). Previous power supply designs were designed to deliver only about 200-300 mA to the magnetron (1000-1200W), which caused the magnetron to operate in the unstable” region, which resulted in significant emissions from 2.3-2.5 GHz, interfering with all WiFi channels. However, since a 50% duty ratio will necessarily require about twice the current to be delivered during the “on” time to maintain the same output power, the magnetron current will be around 500 mA, which will stabilize the frequency. In summary, even when the magnetron is on, only the upper channels will be interfered with, so the “interference” will only occur when the anode current is transitioning up to and down from the 500 mA “on” current. It is intended to keep the total transition times below about 2% of the total cycle time, where can therefore increase the effective “interference free” time ratio from about 50% to greater than about 90%. This difference will be very significant when transferring large amounts of data from client to client via the WiFi router, which can utilize much more of the available router bit rate the comparatively slow internet upload/download speeds.

By providing a new power supply that can use incoming aircraft power, convert it to a frequency that be controlled (and in the process, use a pulser or other device that can cause intermittent delivery of current to the magnetron), it is possible to provide an aircraft microwave oven that will not interfere with Wi-Fi communication.

Changes and modifications, additions and deletions may be made to the structures and methods recited above and shown in the drawings without departing from the scope or spirit of the invention and the following claims.

What is claimed consumed is:

1. A power supply module for use with a microwave oven on-board an aircraft, comprising:
(a) a power converter configured to accept incoming aircraft power and convert the incoming power to controllable high frequency power;
(b) a pulser configured to convert the high frequency power to a lower duty cycle; and
(c) a power amplifier to supply a greater than normal amount of non-continuous outgoing power over bursts of time.

2. The power supply module of claim 1, wherein the power supply module is installed in a microwave that is designed for use on-board an aircraft.

3. The power supply module of claim 1, wherein the lower duty cycle comprises about a 50% duty cycle, such that the power is on about 50% of the time and off about 50% of the time.

4. The power supply module of claim 1, wherein the greater than normal amount of power supplied is about twice the normal amount of power required by a microwave magnetron.

5. The power supply module of claim 4, wherein the power delivered to the magnetron is at about 500 mA

6. The power supply module of claim 1, wherein the power supplied employs 5-100 millisecond bursts over a 10-200 millisecond period.

7. The power supply module of claim 1, wherein the power is supplied in 6-8 millisecond bursts over 16 millisecond cycles.

8. The power supply module of claim 1, wherein the power supply module mimics the behavior of a power supply of a domestic microwave oven.

9. The power supply module of claim 1, wherein the power supply module supplies power to a magnetron of the microwave oven.

10. The power supply module of claim 1, wherein the power supply module is positioned in direct communication with the microwave oven on-board an aircraft.

11. An aircraft galley comprising a microwave oven of claim 1.

12. A method for delivering power to a microwave oven on-board an aircraft, comprising:
(a) converting the incoming aircraft power to a controllable high frequency power;
(b) pulsing the high frequency power at a lower duty cycle; and
(c) delivering a greater than normal amount of non-continuous, outgoing power over bursts of time.
